(19) United States
(12) Patent Application Publication
(10) Pub. No.: US 2020/0206770 A1
(43) Pub. Date: Jul. 2, 2020

(54) DEVICE FOR DISPENSING A SPRAYING AGENT

(71) Applicant: Robert Bosch GmbH, Stuttgart (DE)

(72) Inventors: Bernd Stuke, Leonberg (DE); Jochen Glasbrenner, Stuttgart (DE); Olaf Ohlhafer, Erligheim (DE); Peter Schwaderer, Wildberg (DE)

(21) Appl. No.: 16/646,752

(22) PCT Filed: Sep. 6, 2018
(86) PCT No.: PCT/EP2018/073927

§ 371 Date: Mar. 12, 2020

(30) Foreign Application Priority Data
Sep. 15, 2017 (DE) 10 2017 216 370.4

(51) Int. Cl. B05B 15/20; A01M 7/00; B05B 7/26; B05B 12/00

(52) U.S. Cl. CPC B05B 15/20; B05B 12/002; B05B 7/26; A01M 7/0092

(57) ABSTRACT

A device for dispensing a spraying agent, e.g., a plant protection agent, includes a mixing unit for mixing two active agents to form a spraying agent, at least one of the active agents being suppliable to the mixing unit under pressure via a throttle unit, the throttle unit including a feed channel and a discharge channel that are fluidically connectable to each other via at least one throttle channel depending on a position of a throttle element of the throttle unit that is movably situated relative to the feed channel the discharge channel for setting a flow rate of the at least one active agent to be supplied to the mixing unit, the at least one throttle channel being situated at the throttle element and having a fixed channel cross section for keeping the through-flowing flow rate of the at least one active agent constant.

### CROSS-REFERENCE TO RELATED APPLICATIONS

The present application is the national stage of International Pat. App. No. PCT/EP2018/073927 filed Sep. 6, 2018, and claims priority under 35 U.S.C. § 119 to DE 10 2017 216 370.4, filed in the Federal Republic of Germany on Sep. 15, 2017, the content of each of which are incorporated herein by reference in their entireties.

### FIELD OF THE INVENTION

The present invention is directed to a device for dispensing a spraying agent, in particular a plant protection agent, including a mixing unit for mixing two active agents to form a spraying agent, at least one of the active agents being able to be supplied to the mixing unit under pressure via a throttle unit, the throttle unit having a feed channel and a discharge channel, which are fluidically connectable to each other via at least one throttle channel depending on a position of a throttle element of the throttle unit movably situated relative to the feed channel and the discharge channel for the purpose of setting a flow rate of the at least one active agent to be supplied to the mixing unit.

### BACKGROUND

In conventional agriculture, a large number of active agents are used for fertilization, for supporting growth and, in particular, for protecting the crops. This protection is directed against the infestation of weeds (herbicides), fungus (fungicides), pests (insecticides), and disease. These agents are typically dispensed on the field as aqueous solutions using a hydraulic spraying system. Both the quantity and the composition of the spraying agent or the spray mixture as well as the concentration of the spraying agent (active agents) used must be determined and mixed before the actual application.

DE 10 2004 047 585 A1 describes a spraying device for spraying liquids for agricultural purposes, a constant mixing ratio of active agent and carrier fluid being achieved using a dilution pump.

### SUMMARY

An example embodiment of the present invention is directed to a device where the at least one throttle channel is situated on the throttle element and has a fixed channel cross section for the purpose of keeping the flow rate of the through-flowing active agent constant.

An example embodiment of the present invention is directed to a method for dispensing a spraying agent, in particular a plant protection agent, including the steps of:
providing a mixing unit for mixing two active agents to form a spraying agent;
providing a throttle unit including a feed channel and a discharge channel, which are fluidically connectable to each other via at least one throttle channel depending on a position of a throttle element of the throttle unit movably situated relative to the feed channel and the discharge channel for the purpose of setting the flow rate of at least one of the active agents to be supplied to the mixing unit, the at least one throttle channel being situated at the throttle element and having a fixed channel cross section for the purpose of keeping the flow rate of the at least one through-flowing active agent constant;
supplying at least one of the active agents to the mixing unit under pressure via the throttle unit in such a way that the flow rate of the at least one active agent to be supplied to the mixing unit is kept constant using the throttle unit; and
dispensing the spraying agent.

An example embodiment of the present invention is directed to a method of using a throttle unit for setting a constant flow rate of at least one active agent to be supplied to a mixing unit of a device for dispensing a spraying agent, the throttle unit including a feed channel and a discharge channel, which are fluidically connectable to each other via at least one throttle channel depending on a position of a throttle element of the throttle unit movably situated relative to the feed channel and the discharge channel for the purpose of setting the constant flow rate of the at least one active agent to be supplied to the mixing unit, the at least one throttle channel being situated at the throttle element and having a fixed channel cross section for the purpose of keeping the flow rate of the at least one through-flowing active agent constant.

A device for dispensing a spraying agent can be understood within the scope of the present invention to be a device using which a spraying agent, in particular a liquid spraying agent, can be dispensed or output. The device or dispensing device can be, for example, a plant protection device or a sprayer, in particular a field sprayer. The device can include one or multiple dispensing elements for dispensing the spraying agent. The dispensing element can be, for example, a nozzle element, in particular a spray nozzle. It is conceivable that the device dispenses the spraying agent in the form of a jet or a spray. The device can furthermore include a plurality of tanks for the active agents. The device can be situated on or at a mobile unit, the mobile unit can be designed, in particular, as a farm vehicle, an aircraft, and/or a trailer. The mobile unit can be an agricultural machine, for example a tractor or a (self-propelled or autonomous) field sprayer. The device can be mounted on a hydraulic device of the agricultural machine. It is also conceivable that the device is mounted on a loading platform of the agricultural machine. Alternatively, the device can be hooked up to the agricultural machine.

The spraying agent is preferably dispensed onto a field. In the present case, a field can be understood to be an area used for agricultural purposes, a crop area for plants, or a lot of such an area. The field can thus be piece of agricultural cropland, a grassland, or a pasture. The plants can be, for example, crops whose yield is used for agricultural purposes (for example as food, fodder or as an energy crop) as well as weeds.

The spraying agent can include or be a plant protection agent, in particular a diluted plant protection agent. The spraying agent can therefore include or be, for example, a herbicide, a fungicide, or an insecticide. However, the spraying agent can also include or be a fertilizer, in particular a liquid fertilizer and/or a growth regulator.

The mixed spraying agent and the spraying agent dispensed or to be output do not necessarily have to be identical. In other words, the spraying agent can be modified, for example in its concentration, after being mixed and before being dispensed. The spraying agent can thus be further diluted using another mixing unit. At least one of the active agents can include or be a plant protection agent or a plant protection agent concentrate. The active agent can therefore include or be, for example, an herbicide, a fungicide, or an insecticide. However, the active agent can also include or be a fertilizer or a fertilizer concentrate, in particular a liquid fertilizer and/or a growth regulator. The active agent can be designed as a liquid or as a solid, for example in the form of granulated materials.

However, the active agent can also include or be a carrier fluid, in particular water. Within the scope of the present invention, a carrier fluid can be understood to be a liquid which is designed to be mixed with a plant protection agent, plant protection agent concentrate, fertilizer, or fertilizer concentrate for the purpose of facilitating the dispensing or output of the plant protection agent or the fertilizer, or to improve the dispensing or the output. It is conceivable that a plant protection agent concentrate or fertilizer concentrate is diluted with the carrier fluid. It is also conceivable that a plant protection agent or fertilizer, present as a solid or a granulated material, is suspended in the carrier fluid. It is furthermore conceivable that a plant protection agent or fertilizer that is insoluble in the carrier fluid is emulsified in the carrier fluid.

The active agent supplied or to be supplied to the mixing unit via the throttle unit is preferably a plant protection agent, in particular a plant protection agent concentrate, and the other active agent supplied or to be supplied to the mixing unit is a carrier fluid, in particular water.

A mixing unit within the scope of the present invention can be understood to be a unit designed to mix together at least two active agents to form a spraying agent. The mixing unit can include a mixing and/or stirring element to actively mix together the active agents to be mixed. The mixing unit can have at least one inlet for each of the active agents to be mixed or a shared inlet in the form of a T piece. The mixing unit can have at least one outlet for the mixed spraying agent. It is also conceivable that the mixing unit is a static mixer or a stationary mixer. However, the mixing unit can also be designed only as a T piece, so that a passive mixing takes place therein. The mixing unit can preferably be designed to mix a liquid active agent with a carrier fluid, in particular water, to form a diluted spraying agent having a defined mixing ratio.

The at least one active agent is supplied to the mixing unit under pressure. Both active agents are preferably supplied to the mixing unit under pressure. The pressure can be an overpressure or an underpressure (relative to the surroundings). In other words, the active agent(s) can be supplied to the mixing unit using a pressure force or a suction force. For this purpose, the device can include at least one pressure unit that is designed to supply the at least one active agent, in particular both active agents, to the mixing unit under pressure. The pressure unit can be designed or configured to generate an overpressure at the feed channel. The overpressure can depend on the set throttle channel or on its channel cross section. The pressure unit can include at least one pump unit. The pump unit can be designed to pump, conduct, or convey an active agent from a tank and to supply it to the mixing unit under pressure using at least one fluid conduit, for example a pipe, a hose, a channel, or a tube. Alternatively or additionally, the pressure unit can also include a compressed air unit, so that the at least one active agent or both active agents are conveyed or conducted by applying compressed air to the corresponding active agent and/or the corresponding tank.

However, the pressure unit can also be designed or configured to generate an underpressure at the feed channel. The pressure unit can include at least one pump unit for this purpose. The pump unit can be designed to suck an active agent into the mixing unit from a tank. The pressure unit can be situated downstream from the mixing unit for this purpose.

The throttle unit is designed to set a constant flow rate or volume flow (>0) of the at least one active agent to be supplied to the mixing unit under pressure. In other words, the throttle unit is designed to throttle the flow rate or volume flow of the at least one active agent to be supplied to the mixing unit to a constant flow rate. For this purpose, the throttle unit has a feed channel and a discharge channel, which are fluidically connectable to each other via at least one throttle channel depending on a position of a throttle element of the throttle unit movably situated relative to the feed channel and the discharge channel, the at least one throttle channel being situated at the throttle element and having a fixed channel cross section. The throttle element can also be designed to close the throttle channel depending on its position.

The throttle unit is thus connected before the mixing unit. In other words, the throttle unit is connected upstream from the mixing unit. It is conceivable that the two active agents can each be supplied to the mixing unit via one throttle unit described above. The throttle units can have a different number of throttle channels and/or different channel cross sections. However, it is also conceivable that the other active agent can be supplied to the mixing unit via a different type of throttle valve. The simplest type would be, for example, a throttle valve as a simple, elongated cross-section reduction having a defined diameter. The constricted cross section or tube section can theoretically have any shape, for example even a gap, the hydraulic cross section being decisive.

The throttle element is preferably designed to be manually movable by a user. The entire throttle unit is also preferably designed as a hand valve. Accordingly, the throttle unit can be actuatable without current. In other words, the throttle unit can be designed in such a way that it does not include a motor and/or power connections.

The throttle element of the throttle unit is preferably designed to be manually movable by a user. It is particularly advantageous if the entire throttle unit is designed as a hand valve. The throttle unit can therefore be actuatable without current. In other words, the throttle unit can be designed in such a way that it does not include a motor and/or power connections.

The throttle channel also has a movable design, due to its arrangement at the throttle element. A fluidic connection between the feed channel and the discharge channel can be established or interrupted, depending on the position of the throttle element or the throttle channel.

The throttle channel has a fixed channel cross section. In other words, the throttle channel has a channel cross section with fixed or constant or non-adjustable dimensions. The dimensions of the throttle channel are thus independent of pressure. The channel cross section is the cross section of the throttle channel, through which the active agent is able to flow or through which it flows when supplied.

The throttle units or the channel cross sections as well as the set pressures at which the active agents are supplied to the mixing unit using the pressure unit(s) are matched to each other to obtain a desired mixing ratio. The flow rate depends on the viscosity of the fluid, on the pressure and on the hydraulic diameter. At a nearly identical viscosity and identical pressure, the flow rate is proportionate to the through-flow area (excluding friction effects). For example, if one aims, for example, for an active agent concentration of 10 ml in 1 L of water, the area through which the active agent flows is to be 0.01 times the size of that of the water. A ratio of 1 to 10 then results for the channel cross section of the throttle channel. The pressures (preferably the same for both sides or active agents) can be between 1 and 10 bar (typical for field sprayers). If the pressures are not exactly the same, check valves are still be inserted between the throttle units and the T piece to prevent a back-flow (mixing) in the direction of the tanks. Another possibility arises if one selects pressures equal to the ambient pressure. This automatically ensures the same pressures in both tanks. The driving force for the flow through the throttle units is then an underpressure below the mixing unit. For example, if the mixed active agent is “sucked” out using a pump, the mixing unit is automatically refilled.

The present invention makes use of the fact that spraying agents are mixed in (pre-)mixers of a spraying device at a fixed mixing ratio before being dispensed. The device according to the present invention now provides a structurally very simple and cost-effective approach to mixing a spraying agent to be dispensed at predefined mixing ratios or concentrations. This is achieved, in particular, in that the flow rate of at least one of the active agents flowing through the throttle unit is not pressure-controlled but instead is set using movable, fixed throttle channels, or throttle channels having a fixed channel cross section. The throttle channels are dimensioned according to the desired flow rates, so that the corresponding throttle channel is settable by corresponding positioning of the throttle element, depending on the requirements. The through-flowing flow rate of the first active agent can therefore always be kept constant independently of pressure using the throttle unit, starting at a certain overpressure, which depends on the selected throttle channel, so that a complex control or regulation of the pressure unit or pump can be dispensed with. This, in turn, makes it possible for the throttle element of the throttle unit to be manually movable by a user and for the entire throttle unit to thus be designed as a hand valve.

It is advantageous if at least one additional throttle channel, which is situated at the throttle element and has a fixed channel cross section, is provided. In particular, it is advantageous if the feed channel and the discharge channel are simultaneously fluidically connectable to each other via one and/or via both throttle channels, depending on the position of the throttle element.

The throttle channels advantageously have different channel cross sections, in particular diameters. Due to this measure, a plurality of variation possibilities arise for setting a desired constant flow rate without increasing the complexity of the device.

It is also advantageous if the throttle channel or the throttle channels is/are each designed as bores. Throttle channels can be very easily provided or implemented hereby. It is furthermore advantageous if the throttle channel extends in an arc-shaped manner around a rotation axis of the throttle element or linearly along a movement direction of the throttle element, and/or if the throttle channels are arranged in an arc-shaped manner around a rotation axis of the throttle element or linearly along a movement direction of the throttle element. In particular, it is advantageous if the movement of the throttle elements is a rotational, in particular purely rotational, movement around a rotation axis of the throttle element or a translational, in particular purely translational, movement transverse to a flow direction of the active agent through the throttle channel. The rotation axis of the throttle element preferably runs outside the throttle channel or the throttle channels and/or essentially in parallel to a flow direction of the active agent through the throttle channel. Due to this measure, the position of the throttle element can be very easily selected or changed, and the desired throttle channel can be set thereby.

It is also advantageous if the feed channel is situated at a feed element and the discharge channel is situated at a discharge element, the feed element and the discharge element essentially having the same design. It is particularly advantageous if the feed element, the throttle element, and the discharge element are designed as disks, in particular as circular disks having the same size and also being situated adjacent and in parallel to each other. A ceramic is preferred as the disk material, due to the low wear tendency and relatively good tightness (smooth surfaces). The throttle unit is designed as a type of (revolver) drum, so that the corresponding throttle channel can be set or selected by rotating, in particular manually rotating, the throttle element.

In an example embodiment, the feed element and/or the discharge element is/are flexibly situated against the throttle element; and the throttle element has at least one projection on a surface facing the feed element and/or the discharge element, using which the throttle element is guidably supported in a groove of the feed element and/or the discharge element, and/or the throttle element has a groove on the surface facing the feed element and/or the throttle element, using which the throttle element is guidably supported on at least one projection of the feed element and/or the discharge element.

Due to the combination of a projection, for example in the shape of a hemisphere, at one of the elements and a diametrically opposed, circumferential groove or recess at an adjacent element, a fixing of the elements to each other in the radial direction is therefore made possible. The groove can advantageously have indentations, for example in the form of half shells, to permit a locking of the elements to each other in the circumferential direction in predefined positions or at predefined angles. Since the projections extend into the indentations and are thus bigger than the grooves, the distance to the feed element or the discharge element increases during the movement of the throttle element or the projection from one indentation to the next, so that wear on the contact surfaces is avoided.

Example embodiments of the present invention are illustrated in the drawings and explained in greater detail in the description below.

### BRIEF DESCRIPTION OF THE DRAWINGS

FIG. 1 shows a schematic representation of a device for dispensing a spraying agent, according to an example embodiment of the present invention.

FIGS. 2-4 show a schematic representation of an example embodiment of the throttle unit from FIG. 1, according to an example embodiment of the present invention.

FIG. 5 shows a schematic representation of an example embodiment of a throttle unit, including a locking device, according to an example embodiment of the present invention.

FIGS. 6 and 7 show schematic representations of example embodiments of throttle units including an elongated throttle channel, according to example embodiments of the present invention.

FIG. 8 is a flowchart of a method according to an example embodiment of the present invention.

### DETAILED DESCRIPTION

In the following description of advantageous example embodiments of the present invention, the same or similar reference numerals are used for the elements which are illustrated in the various figures and have similar functions, a repeated description of these elements being dispensed with.

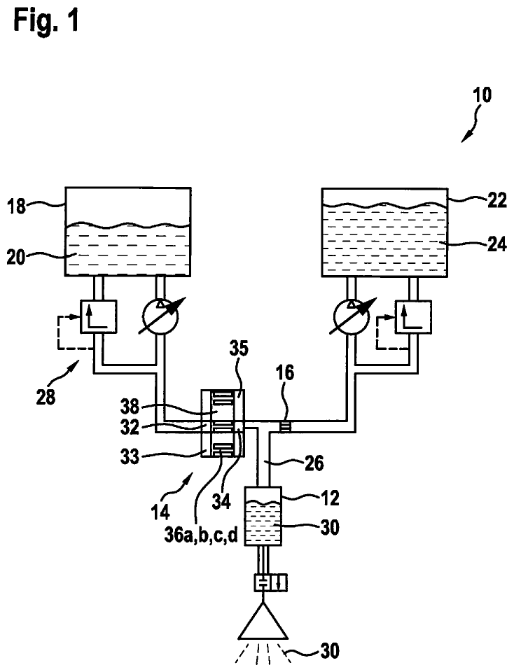

FIG. 1 shows a device for dispensing a spraying agent, or a spraying device according to the present invention which, in its totality, is provided with reference numeral 10.

Spraying device 10 includes a mixing unit 12, a throttle unit 14, and a throttle valve 16. Spraying device 10 furthermore includes a tank 18, in which a first active agent 20 is situated, as well as a tank 22, in which a second active agent 24 is situated. First active agent 20 is designed as a plant protection agent concentration 20, and second active agent 24 is designed as a carrier fluid 24, namely water 24.

First active agent 20 and second active agent 24 can be supplied to mixing unit 12 under pressure via supply lines 26, the pressure being able to be generated via a pressure unit 28 in each case. Mixing unit 12, in turn, is designed to mix the two active agents 20, 24 to form a spraying agent 30.

Throttle unit 14 is situated upstream from mixing unit 12 between tank 18 and mixing unit 12. Throttle unit 14 includes a feed channel 32 and a discharge channel 34, which are fluidically connectable to each other via one of four throttle channels 36a, b, c, d in each case for the purpose of setting a flow rate of first active agent 20 to be supplied to mixing unit 12. Feed channel 32 is situated at a feed element 33, and discharge channel 34 is situated at a discharge element 35. Throttle channels 36a, b, c, d are situated at a throttle element 38 that is movably situated relative to feed channel 32 or feed element 33 and discharge channel 34 or discharge element 35, which each has a fixed channel cross section. The channel cross sections are different, which is apparent from the following figures. The fluidic connection or the selection of throttle channels 36a, b, c, d, and thus the flow rate, takes place depending on a position of throttle element 38. Starting at a certain overpressure, which depends on selected throttle channel 36a, b, c, d, the through-flowing flow rate of first active agent 20 can be kept always constant independently of the pressure using throttle unit 14. Throttle element 38 is designed to be manually movable by a user, for which reason throttle unit 14 is designed as a hand valve 14.

Throttle valve 16 is designed as a pipe constriction. However, it would also be entirely conceivable to provide another throttle unit instead of throttle valve 16, but with a different number of throttle channels and/or different channel cross sections. Accordingly, second active agent 24 can be supplied to mixing unit 12 under pressure via fixed throttle valve 16, the constant flow rate being invariable in contrast to throttle unit 14.

Consequently, depending on the desired mixing ratio of spraying agent 30, i.e., that of first active agent 20 or plant protection agent concentrate 20, to second active agent 24, or water 24, throttle element 38 and thus particular throttle channel 36a, b, c, d are positioned accordingly, so that the corresponding flow rate of plant protection agent concentrate 20 is supplied to mixing unit 12 in the ratio to water 24. Throttle unit 14 and throttle valve 16 as well as the pressures at which active agents 20, 24 are supplied to mixing unit 12 are to be matched to each other to obtain the desired mixing ratio.

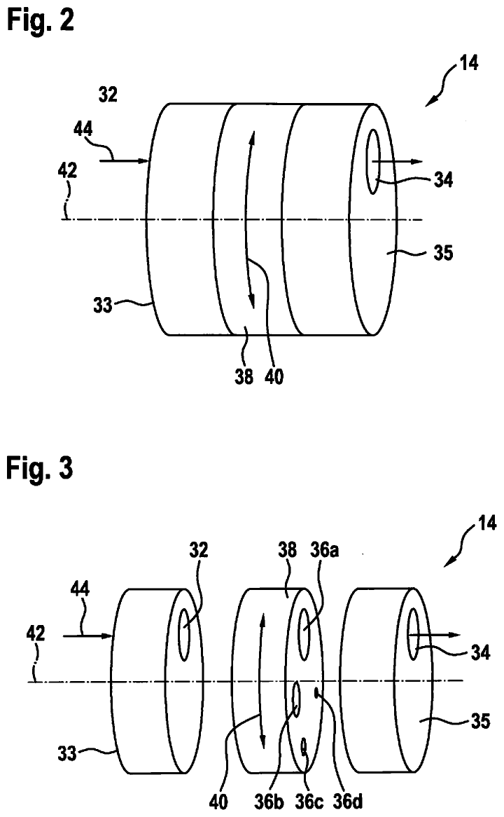

FIGS. 2-4 show an example embodiment of a throttle unit 14 according to the present invention. Feed element 33, discharge element 35 and throttle element 38 are designed as circular disks and are situated adjacent and in parallel to each other. Throttle element 38 is rotatably supported around rotation axis 42 in movement direction 40. The movement of throttle element 38 is a purely rotational movement. Rotation axis 42 runs outside throttle channels 36a, b, c, d, so that throttle channels 36a, b, c, d are also rotatably movable around rotation axis 42. Moreover, rotation axis 42 of throttle element 38 runs essentially in parallel to flow direction 44 of the active agent through throttle channels 36a, b, c, d.

As is apparent in greater detail from the exploded drawing in FIG. 3, a fluidic connection of feed channel 32 to discharge channel 34 takes place via one of throttle channels 36a, b, c, d in flow direction 44 depending on the position of throttle element 38. Throttle channels 36a, b, c, d, designed as bores 36a, b, c, d, all have fixed channel cross sections, whereby the through-flowing flow rate is kept constant. The channel cross sections or diameters of throttle channels 36a, b, c, d are different, so that, depending on the desired quantitative ratio of plant protection agent concentrate 20 to water 24, corresponding throttle channel 36a, b, c, d (36a in the illustrated case) can be selected for the fluidic connection by rotating throttle element 38 in movement direction 40. Feed channel 32 and discharge channel 34 can be simultaneously fluidically connected via only one throttle channel 36a, b, c, d. However, it is also entirely conceivable to select the diameter and arrangement of channels 32, 34, 36a, b, c, d in such a way that feed channel 32 and discharge channel 34 are simultaneously fluidically connectable via two or even more throttle channels 36a, b, c, d.

A detailed view of elements 33, 35, 38 is illustrated in FIG. 4, from which it is apparent that throttle channels 36a, b, c, d are arranged circularly around rotation axis 42 of throttle element 38.

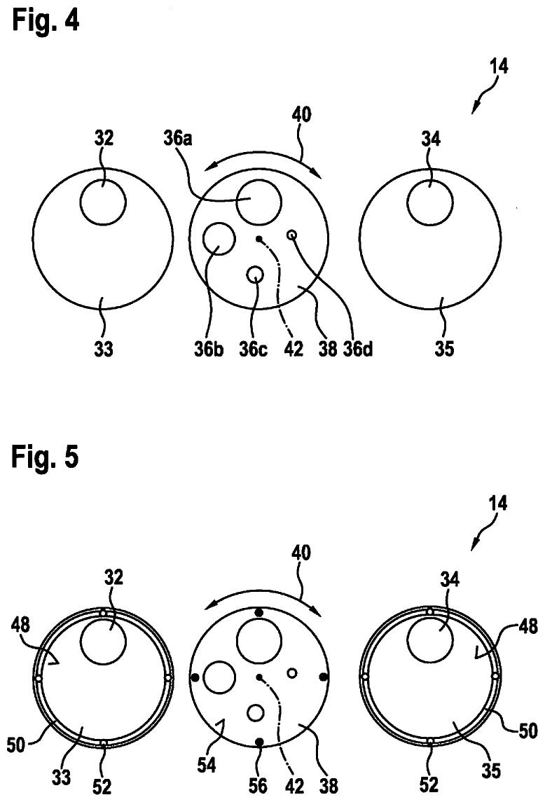

FIG. 5 shows another example embodiment of a throttle unit 14 according to the present invention, including a locking device of throttle element 38 in predefined positions, i.e., a locking device of throttle element 38 at predefined angles relative to feed element 33 and discharge element 35. For illustrative reasons, a detailed view is shown similarly to FIG. 4.

To be able to provide the locking device, feed element 33 and discharge element 35 are each flexibly situated or supported against throttle element 38 using a pressure spring (not illustrated). In addition, feed element 33 and discharge element 35 each have a circular groove 50 or channel 50 on a surface 48 facing throttle element 38, including four hemispherical indentations 52 evenly distributed in the circumferential direction. Accordingly, throttle element 38 includes four hemispherical projections 56 in each case on a surface 54 facing feed element 33 and discharge element 35. Similarly to hemispherical indentations 52, hemispherical projections 56 are evenly distributed in the circumferential direction. As a result, throttle element 38 is guidably supported and lockable in grooves 50 or indentations 52 of feed element 33 and discharge element 35 using projections 56. When throttle element 38 is rotated out of a locking position, the distance from feed element 33 and discharge element 35 increases in each case until the next locking position is reached, so that wear on contact surfaces 48, 54 is avoided. In addition, feed channel 33 and discharge channel 35 can be sealed using a sealing element, for example an O ring.

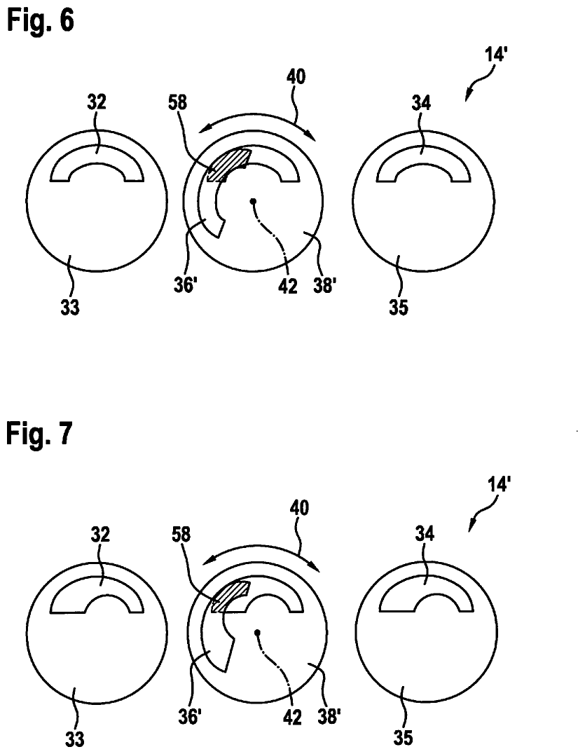

FIGS. 6 and 7 show two additional example embodiments of a throttle unit 14′, including only one throttle channel 36′. Throttle channel 36′ has an elongated design and extends in an arc-shaped manner around rotation axis 42 of throttle element 38′. Feed channel 32 of feed element 33 and discharge channel 34 of discharge element 35 are adapted accordingly. The flow rate of through-flowing active agent 20 is determined by an overlapping surface 58 between throttle channel 36′ and feed channel 32 or discharge channel 34. The flow rate is thus continuously changeable or settable. As illustrated in FIG. 6, channels 32, 34, 36′ can have a symmetrical design, so that a uniform elevation of overlapping surface 58 results for each angle unit. Alternatively, however, channels 32, 34, 36′ can also have an asymmetrical design—as illustrated in FIG. 7—so that a different elevation of overlapping surface 58 results for each angle unit.

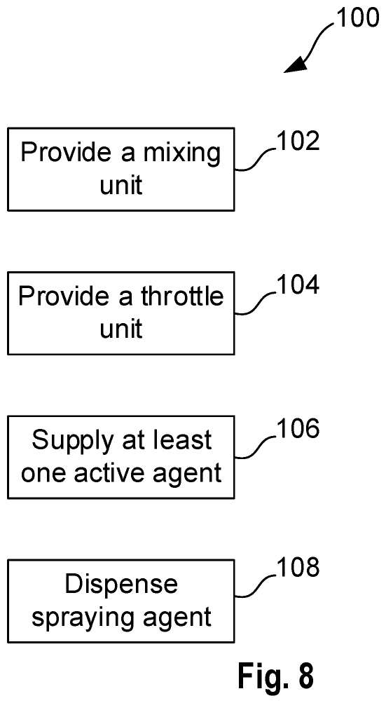

FIG. 8 is a flowchart of an example embodiment of the approach presented here as method 100 for dispensing a spraying agent 30, in particular a plant protection agent 30. Method 100 includes a step 102 of providing a mixing unit 12 for mixing two active agents 20, 24 to form a spraying agent 30. Method 100 also includes a step 104 of providing a throttle unit 14; 14′ including a feed channel 32 and a discharge channel 34, which are fluidically connectable to each other via at least one throttle channel 36a, b, c, d; 36′ depending on a position of a throttle element 38; 38′ of throttle unit 14; 14′ movably situated relative to feed channel 32 and discharge channel 34 for the purpose of setting the flow rate of at least one of active agents 20, 24 to be supplied to mixing unit 12, the at least one throttle channel 36a, b, c, d; 36′ being situated at throttle element 38; 38′ and having a fixed channel cross section for the purpose of keeping the flow rate of the at least one through-flowing active agent 20, 24 constant. Method 100 further includes a step 106 of supplying at least one of active agents 20, 24 to mixing unit 12 under pressure via throttle unit 14; 14′ in such a way that the flow rate of the at least one active agent 20, 24 to be supplied to mixing unit 12 is kept constant using throttle unit 14; 14′. Finally, method 100 includes a step 108 of dispensing spraying agent 30.

If an example embodiment includes an “and/or” linkage between a first feature and a second feature, this is to be read in such a way that the example embodiment has both the first feature and the second feature according to an example embodiment and either only the first feature or only the second feature according to other example embodiments.

1-16. (canceled)

17. A device comprising:
a throttle that includes a feed channel and a discharge channel that are fluidically connectable to each other via at least one throttle channel depending on a position of a movable part of the throttle;
a mixer;
wherein:
the mixer is configured to mix two active agents to form a spraying agent;
at least one of the active agents is suppliable to the mixer under pressure via the throttle at a flow rate that is set by movement of the movable part relative to the feed channel and the discharge channel;
the at least one throttle channel is situated at the movable part and has a fixed channel cross section for keeping a through-flowing flow rate of the at least one of the active agents constant.

18. The device of claim 17, wherein the at least one throttle channel includes at least two throttle channels that each is situated at the movable part and has a constant channel cross section.

19. The device of claim 18, wherein the feed channel and the discharge channel are simultaneously fluidically connectable to each other via one or more of the at least two throttle channels, depending on the position of the movable part.

20. The device of claim 18, wherein the throttle channels include different channel cross sections.

21. The device of claim 18, wherein the throttle channels include different channel diameters.

22. The device of claim 17, wherein each of the at least one throttle channel is designed as a bore.

23. The device of claim 17, wherein the at least one throttle channel:
extends in an arc-shaped manner around a rotation axis of the movable part or linearly along a movement direction of the movable part; and/or
is arranged in a circular manner around the rotation axis of the movable part or linearly along the movement direction of the movable part.

24. The device of claim 17, wherein the movement of the movable part is a rotational movement around a rotation axis of the movable part or a translational movement transverse to a flow direction of the active agent through the at least one throttle channel.

25. The device of claim 24, wherein the rotation axis of the movable part runs outside the at least one throttle channel.

26. The device of claim 24, wherein the rotation axis of the movable part runs essentially in parallel to the flow direction of the active agent through at least one throttle channel.

27. The device of claim 17, further comprising a feed and a discharge that have essentially the same design as each other, wherein the feed channel is situated at the feed and the discharge channel is situated at the discharge.

28. The device of claim 27, wherein the feed, the movable part and the discharge are respective disks that are situated adjacent and parallel to one another.

29. The device of claim 28, wherein the disks are circular.

30. The device of claim 27, wherein
each of at least one of the feed and the discharge is flexibly situated against the movable part; and
the movable part includes at least one projection on a surface facing the feed and/or the discharge, by which the movable part is guidably supported in a groove of the feed and/or a groove of the discharge element.

31. The device of claim 27, wherein:
each of at least one of the feed and the discharge is flexibly situated against the movable part; and
the movable part includes a groove on a surface facing the feed by which the movable part is guidably supported at at least one projection of the feed.

32. The device of claim 27, wherein:
each of at least one of the feed and the discharge is flexibly situated against the movable part; and
the movable part includes a groove on a surface facing the discharge by which the movable part is guidably supported at at least one projection of the discharge.

33. The device of claim 17, wherein the movable part is manually movable by a user.

34. The device of claim 33, wherein the throttle is a hand valve.

35. The device of claim 17, wherein the at least one active agent is a plant protection agent.

36. The device of claim 17, wherein the at least one active agent is a plant protection agent concentrate.

37. The device of claim 17, wherein the at least one active agent is a carrier fluid.

38. The device of claim 17, wherein the at least one active agent is water.

39. A method comprising:
supplying to a mixer at least one of two active agents that are to be mixed by the mixer to form a spraying agent, wherein:
the supplying is performed under pressure via a throttle;
the throttle includes a feed channel and a discharge channel that are fluidically connectable to each other via at least one throttle channel depending on a position of a movable part of the throttle;
the supplying is at a flow rate that is set by movement of the movable part of the throttle relative to the feed channel and the discharge channel;
the at least one throttle channel is situated at the movable part and has a fixed channel cross section for keeping the flow rate of the supplying constant; and
dispensing the spraying agent.

40. A method comprising:
setting a constant flow rate of an active agent being conducted to a mixer for dispensing a spraying agent, the setting being performed using a throttle, wherein:
the throttle includes a movable part, at least one throttle channel, a feed channel, and a discharge channel that is fluidically connectable to the feed channel via the at least one throttle channel depending on a position of the movable part;
the movable part is movably situated relative to the feed channel and the discharge channel for the setting of the constant flow rate;
the at least one throttle channel is situated at the movable part and has a fixed channel cross section that keeps the flow rate constant.
